(19) United States
(12) Patent Application Publication
(10) Pub. No.: US 2004/0023924 A1
(43) Pub. Date: Feb. 5, 2004

(54) Use of xyloglucan polymers and oligomers, and derivative compounds, as phytosanitary products and biofertilizers

(76) Inventor: Yvette Lienart, Uriage (FR)

Correspondence Address: YOUNG & THOMPSON, 745 SOUTH 23RD STREET 2ND FLOOR, ARLINGTON, VA, 22202

(21) Appl. No.: 10/381,666

(22) PCT Filed: Sep. 27, 2001
(86) PCT No.: PCT/FR01/03001

(30) Foreign Application Priority Data
Sep. 27, 2000 (FR) 00 12315

(51) Int. Cl. A01N 43/04; A01N 43/02

(52) U.S. Cl. 514/54; 504/291

(57) ABSTRACT

The invention concerns the use of a compound comprising a polysaccharide structure of formula X₁-X₂-X₃-(X₄)ₙ wherein: X₁, X₂, X₃ and X₄, independently of one another, represent a monosaccharide selected among glucose, galactose, xylose, fucose, or arabinose, the monosaccharide being optionally in reduced form and/or substituted, in particular by an alkyl or acyl group, such as a methyl or acetyl group; and n represents 0 or 1, for adapting plants to abiotic stress, flowering control, fructification control, and for inducing defense reactions against pathogens.

A subject of the present invention is new uses of xyloglucan polymers or oligomers, as well as of derived compounds, in the phytosanitary field, and that of biofertilization.

The cell walls of fruits and vegetables are formed by polysaccharides, of which chiefly pectin, cellulose and xyloglucan are involved in putting the wall in place (Levy S et al., Plant J. 1997, 11(3): 373-86). Xyloglucan is also found in large quantities in the endosperm of the seeds of the Dicotyledons.

Xyloglucan is a 1,4-β-glucan polymer substituted differently according to its origin. In the Dicotyledons, the substitutions of the 1,4 β-D-glucan linear chains most often involve 1,6 α-D-xylosyl-, or 1,6 α-D-xylose- 1,2 β-D-galactosyl-type branchings, and fucose can be associated, at the terminal position, with the galactose, i.e. a 1,6 α-D-xylose 1,2 β-D-galactose 1,2 α-L-fucosyl-type side branching. Always in the dicotyledones, the fucose residue is absent from the endosperm, and it can be replaced by the α-L-arabinose residue, for example in certain Solanaceae. The xyloglucan of the Monocotyledons differs from that of the Dicotyledons by a lower rate of substitution by the xylose, galactose residues and by the absence of fucose. The xyloglucan forms with the cellulose microfibres the bridge structures which constitute the structure and ensure the flexibility of the cell wall of vegetables (Pauly M, Albersheim P, Darvill A, York W S (1999) Plant J. 20 (6): 629-39).

Xyloglucan is a substrate of endoxyloglucanases (Vincken J P, Beldman G, Voragen A G Carbohydr Roes (1997) 13, 298(4):299-310) or of xyloglucan endotransglycosylase (Steele N M, Fry S C, Biochem J (1999) 15, 340, 1, 207-211), namely of enzymatic activities capable of modifying the structure of the cell walls during cell elongation, in the germination, fructification periods for example and which are dependent on hormones, in particular auxins (Hetherington P R and Fry S. (1993) Plant Physiology, 103, 987-992), and gibberellins (Maclachlan G and Brady C (1994) Plant Physiol 105, 965-974).

Xyloglucan, in particular a fucosylated oligomer, the nonasaccharide XXFG (described in Fry et al. (1993) Physiologia Plantarum, 89, 1-3), is well known for its antiauxinic effect (Mac Dougall C J and Fry S C (1989) Plant Physiol 89, 883-887). Conversely, oligomers without fucose but with galactose such as the oligomers XXLG and XLLG have an auxinic effect (Mc Dougall G J and Fry S C (1990) Plant Physiology 93, 1042-1048).

Moreover, a number of signals generate activated oxygen species (also referred to as “oxidative burst”). Active oxygen species are well known for being released during plant-pathogen interactions. Oligosaccharides of various origin (polygalacturonic acid, chitosan, 0-glycans etc.) have been recorded for their ability to generate an oxidative burst (Low P S and Heinstein P F (1986) Arch. Biochem. Biophys. 249, 472-479; Rogers KR., Albert F, and Anderson A J (1988) Plant Physiol 86, 547-553; Apostol I, Heinstein P F and Low P S (1989) Plant Physiol 90, 109-116; Vera-Estrella R, Blumwald E and Higgins V J (1992) Plant Physiol. 1208-1215; Bolwell G P, Butt V S, Davies D R and Zimmerlin A. (1995) Free Rad. Res. Comm. 23, 517-532; Orozco-Cardenas M and Ryan C A (1999) PNAS, 25, 96, 11, 6553-655; Nita-Lazar M, Iwahara S, Takegawa K, Lienart Y (2000) J Plant Physiol, 156, 306-311). Oxidoreductase NAD(P)H enzymes for the release of superoxide anion (Van Gestelen P V, Asard A, Caubergs R J (1997) Plant Physiol 115, 543-550) and peroxidase enzymes for the formation of peroxide or of superoxide anion or of OH radicals are involved (Baker C J and Orlandi E W (1995) Ann. Rev. Phytopathol, 33, 299-321; Chen S X and Schopfer P (1999) Eur Bioch 260, 726-735). Other signals (salicylic acid, jasmonates, cGMP, NO etc.) also generate a burst (Chen Z, Malamy J, Henning J, Conrath U, Sanchez-Casas P, Silva H, Ricigliano J, Klessig D F (1995) Proc Natl Acad Sci USA, 92, 4134-4137; Voros K, Feussner I, Kuhn H, Lee J, Graner A, Lobler M, Parthier B, Wastemack C Eur J Biochem (1998) 15, 251, 36-44; Durner J, and Klessig J, Wendehenne D, Klessig D F (1998) Proc Natl Acad Sci USA, 95, 10328-10333; Durner D and Klessig D F (1999) Current Opinion in Plant Biology, 2, 369-374).

Extreme environmental conditions (drought, cold, UV, salinity etc.) trigger the same effect.

The major role of H₂O₂ in the generation of the burst as in the regulation of oxidant stress is based on:

its formation by dismutation from the superoxide anion (Bolwell G P, Davies D R, Gerrish C, Auh C K and Murphy T M (1998) Plant Physiol 116, 1379-1385),

its use in C₁₈ fatty acid metabolism sequences (for the peroxidation of lipids (Koch E, Meier B M, Eiben H-G, Slusarenko A (1992) Plant Physiol 99, 571-576) or for the synthesis of octadecanoids and of their derivatives, certain of which such as the methyl-jasmonates are metabolites with a hormonal function,

its function as substrate for the peroxidase and catalase enzymes, property of limiting the accumulation of toxic peroxide for the cell (Baker C J, Harmon G L, Glazener J A and Orlandi E W (1995) Plant Physiol, 108, 353-359).

The active oxygen species, the superoxide anion in particular, control different metabolic routes. They are involved in:

the biosynthesis of polyamines: monoamines are oxidized to aldehydes with production of NH₃ and peroxide. The oxidation of L-arginine by nitrite synthase results in the formation of a polyamine precursor (L-citrulline),

the synthesis of ethylene,

the synthesis of gibberellins. More than 20 oxidases are involved in the regulation of the biosynthesis of gibberellins.

The active oxygen species are involved in signal transduction stages, because they are associated with receptor bond activity or transduction enzyme activity (Jabs T, Tschöpe M, Colling C, Hahlbrock K and Scheel D (1997) Proc Natl Acad Sci USA 29, 94, 9, 4800-4805; Durner J, Wendehenne D, Klessig D F (1998) Proc Natl Acad Sci USA, 95, 10328-10333).

They are involved in the regulation of the cell redox potential using thiol groups (GSSG-GSH, cystine-cysteine conversion, etc.). In this way, they control senescence processes which are manifested during certain flowering and fructification phases in different organisms.

The oxidative burst interferes with the hormonal metabolism, the most efficient potential for regulating the flowering and fructification stages (in particular their triggering and their duration are programmed by a hormonal balance (auxin/cytokinin ratio for example), and the active oxygen species, including peroxide, control the synthesis of polyamines).

The present invention results from the revealing by the Inventors of the fact that xyloglucan polymers and oligomers, as well as compounds derived from the latter, have a stimulating effect on the glutathione reductase enzyme, the phospholipase D enzyme in plants, as well as the glycosylhydrolases.

By stimulating the glutathione reductase enzyme, the xyloglucan polymers and oligomers trigger the reactions of adaptation to any oxidant stress, such as cold in particular, by limiting the toxic effects of the active oxygen species (Allen R D, Webb R P, Schake I T S (1997) Free Radic Biol Med, 23 (3):473-479; O'Kane D, Gill V, Boyd P, Burdon R (1996) Planta, 198 (3):371-377), and they regulate the redox potential of the cell, which modifies the activity of enzymes or of thiol-dependent proteins, phospholipase D, thiol-proteases and inhibitors of thiol-proteases in particular (Taher M M, Mahgoub M A, Abd-Elfattah (1998) AS Biochem Mol Biol Int 46 3, 619-28), as well as by a thiol-dependent protease inhibitor induction effect, and without however activating a cascade of other enzymatic systems in proportions harmful to the plant.

By stimulating the phospholipase D activity, the xyloglucan polymers and oligomers amplify the hormonal effect of abscisic acid to the extent that the activation of the enzyme leads to the production of phosphatidic acid (which mimics the effects of abscisic acid). In this way, they can reveal an antagonism against the gibberellins, ethylene or jasmonates (Grill E., Himmelbach A. (1998) Current Opinion in Plant Biology, 1, 1, 5, 412-418; Ritchie S, Gilroy S (1998) Plant Biology, 95, 5, 3, 2697-2702; Moons A, Prinsen E, Bauw G, Van Montagu M (1997) Plant Cell 9 12, 2243-59).

At present, apart from chemical fertilizers, the control of vegetable development is based chiefly on:

the use of agricultural compositions enriched with trace elements, nitrate, phosphate and potassium compounds, polyamines or certain hormones,

the use of natural or genetically modified micro-organisms, which improve the quality of the soil, promoting vegetable growth or increasing crop yield; these are in particular the Rhizobiacea such as R. meliloti and B. japonicum, free-nitrogen-fixing bacteria, such as Bacillus and Pseudomonas, and fungi such as Penicillium,

the development of transgenic plants. This technology has come up against legal problems and strong opposition on the part of consumers; moreover, it has not yet resulted in satisfactory uses in the biofertilizer sector.

One of the aims of the present invention is to provide new compositions which can be used in the phytosanitary field and in biofertilization, and more particularly to combat abiotic stress in plants, and to control flowering and fructification.

A subject of the present invention is the use of a compound comprising an osidic structure of formula:

X₁-X₂-X₃-(X₄)ₙ

in which X₁, X₂, X₃, and X₄, independently from one another, represent a sugar chosen from glucose, galactose, xylose, fucose, or arabinose, this sugar optionally being in reduced form and/or being substituted, in particular by an alkyl or acyl group, such as a methyl or acetyl group, and n represents 0 or 1,

X₁, X₂, X₃, and X₄, independently from one another, being optionally substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1,

at least one of X₁, X₂, X₃, or X₄, or, optionally, of X₅, X₆, or X₇ representing a xylose or a fucose,

or of a compound derived from those defined above, in particular by modification or substitution of one or more above-mentioned sugars, said compounds and their derivatives having the property:

of stimulating glutathione reductase, and therefore in this way of inducing anti-oxidative defence reactions (also designated oxidant stress adaptation reactions), in particular by changing the cell redox potential and/or by activation of a thiol-dependent protease inhibitor,

and/or of stimulating phospholipase D in plants, and therefore in this way of amplifying the hormonal effect of abscisic acid,

and/or of stimulating glycosylhydrolases, and therefore in this way of inducing defence reactions against pathogens (by a mechanism of lysis of micro-organisms by enzymatic degradation of their cell walls) and/or of controlling certain phases of plant development (germination, fertilization, cell differentiation during flowering or fructification),

within the scope of uses linked to the above-mentioned properties of said compounds, namely:

the adaptation of plants to an abiotic stress, such as adaptation to the cold, or to a hydric stress such as drought, humidity or salinity (Tao D L, Oquist G, Wingsle G (1998) Cryobiology 37, 1, 38-45; Gueta-Dahan Y, Yaniv Z, Zilinska B A, Ben Hayyim G (1997) Planta, 203, 4, 460-469),

the control of flowering,

the control of fructification,

the induction of defence reactions against pathogens such as bacteria, viruses, fungi.

By control of flowering is meant more particularly control of the key phases of the flowering process such as antheresis (Wang M, Hoekstra S, van Bergen S, Lamers G E, Oppedijk B J, Heijden M W, of Priester W, Schilperoort R A (1999) Plant Mol Biol 39, 3:489-501), or the development of flower buds (Lim C O, Lee I F, Chung W S, Park S H, Hwang I, Cho M J (1996), Plant Mol Biol, 30, 2, 373-379), such as the floral induction or abscission phases (Colasanti J, Sundaresan V (2000) Trends Biochem Sci, 25, 5, 236-240.

By control of fructification is meant more particularly control of the triggering and/or duration of the maturation phase (Fan L, Zheng S, Wang X (1997) Plant Cell, 9, 12, 2183-9; Ryan S N, Laing W A, Mc Canus M T (1998), Phytochemistry, 49, 4, 957-963), control of cell wall metabolism with respect to the accumulation of sugars and phenols (Fillion L, Ageorges A, Picaud S, Coutos-Thevenot P, Lemoine R, Romieu C, Delrot S (1999) Plant Physiol 120 (4):1083-94), and control of leaf and fruit abscission (Gomez-Cadenas A, Mehouachi J, Tadeo F R, Primo-Millo E, Talon M (2000), Planta, 210, 4, 636-643).

The induction of defence reactions against pathogens is, with respect to the elicitation of PR-proteins, in particular of the enzymes 1,3-β-D glucanase and endochitinase, also known to be involved in plant development (Munch-Garthoff S, Neuhaus J M, Boller T, Kemmerling B, Kogel K H (1997) Planta 201, 2, 235-44; Buchter R, Stromberg A, Schmelzer E, Kombrink E (1997) Plant Mol Biol 35, 6, 749-61; Robinson S P, Jacobs A K, Dry I B (1997) Plant Physiol 114, 3, 771-8).

The control of metabolic and catabolic modifications of which certain tissues are the object in differentiation or senescence periods, is in accordance with the elicitation of the enzymes 1,4-β-D-glucanase and β-D-xylosidase (Trainotti L, Spolaore S, Ferrarese L, Casadoro G (1997) Plant Mol Biol 34 (5):791-802; Kalaitzis P, Hong S B, Solomos T, Tucker M L (1999) Plant Cell Physiol 40(8), 905-8).

A more particular subject of the invention is the above-mentioned use of compounds in which the sugars are (L) or (D) glycosyl residues, optionally in reduced form, and/or in α or β form, optionally in pyranose or furanose form, and are interconnected by bonds of the 1→2, 1→3, 1→4, or 1→6 type, and more particularly of the α1→2 type in the case of the bond of a fucose to a galactose, β1→2 in the case of the bond of a galactose to a xylose, 1-4, in the case of the bond of a glucose to a glucose, or α1→6, in the case of the bond of a xylose to a glucose.

A yet more particular subject of the invention is the above-mentioned use of compounds of formula:

X₁-X₂-X₃-(X₄)ₙ

in which X₁, X₂, X₃, and X₄, independently from one another, represent a sugar chosen from glucose, galactose, xylose, fucose, or arabinose, and n represents 0 or 1, at least one of X₁, X₂, X₃, or X₄, representing a xylose or a fucose.

Therefore, the invention relates more particularly to the above-mentioned use:

of compounds of formula:

X₁-X₂-X₃-(X₄)ₙ

in which:

X₁ represents fucose,

X₂ represents a galactose,

X₃ represents xylose or glucose,

X₄ represents a glucose, optionally substituted by a sugar such as glucose,

each of X₁, X₂, X₃, and X₄ being (L) or (D) glycosyl residues in α or β form, and n represents 0 or 1,

X₁, X₂, X₃, and X₄, being optionally substituted, in particular by an alkyl group, such as a methyl group,

such as the compounds of formula:

α-L-Fuc(1→2)β-D-Gal(1→2)α-D-Xyl,

α-L-Fuc(1→2)β-D-Gal(1→4)β-D-Glc, or 2′-fucosyl lactose (the process for obtaining which from milk or urine is more particularly described in Charlwood J, Tolson D, Dwek M, Camilleri P (1999) Anal Biochem 10, 273, 2, 261-77),

methyl(α-L-Fuc(1→2)β-D-Gal(1→2)β-D-Xyl) or methyl(α-L-Fuc(1Θ2)β-D-Gal(1→2)α-D-Xyl) (the process for obtaining which is more particularly described in Lopez R, Montero E, Sanchez F, Canada J, Fernandez-Mayoralas A (1994) J Org Chem 59, 7027-7032; Watt DK, Brasch D J, Larsen D S, Melton L D, Simpson J (2000) Carbohydr Roes, 5, 325(4):300-12),

α-L-Fuc(1→2)β-D-Gal(1→2)α-D-Xyl(1→6)β-D-Glc,

α-L-Fuc(1→2)β-D-Gal(1→2)β-D-Xyl(1→6)β-D-Glc,

α-L-Fuc(1→2)β-D-Gal(1→2)α-D-Xyl(1→6)α-D-Glc(1→4)α-D-Glc, also designated FG (described in Fry et al. (1993) Physiologia Plantarum, 89, 1-3), and the process for preparation of which by chemical synthesis is described in Pavlova Z N, Ash A O, Vnuchkova V A, Babakov A V, Torgov V I, Nechaev O A, Usov A I, Shibaev V N (1992) Plant Science 85, 131-134, and the process for preparation of which by hydrolysis and chromatography is described in Vincken J P, Beldman G, Niessen W M A, Voragen A G J (1996) Carbohydrate Polymers, 29, 1, 75-85,

the osidic residue in position X₃ when n=0, or in position X₄, or substituting that in position X₄, in the formulae of the compounds above, being optionally in reduced form,

or compounds of formula:

α-D-Gal(1→2)β-D-Xyl(1→6)β-D-Glc(1→4)β-D-Glc also designated LG

α-D-Xyl(1→2)β-D-Gal(1→2)β-D-Xyl

α-D-Xyl(1→6)β-D-Glc(1→4)β-D-Glc also designated XG

β-D-Xyl(1→4)β-D-Glc(1→4)β-D-Glc isolated from Ulva lactuca (Lahaye M, Jegou D, Buleon A (1994), Carbohydrate Research 262, 115-125)

α-D-Xyl(1→2)β-D-Glc(1→4)β-DGlc

β-L-Ara(1→3)α-L-Ara(1→2)α-D-Xyl compound T (York W S, Kumar Kolli V S, Orlando R, Albersheim P, Darvill A G (1996) Carbohydr Roes 285, 99-128) 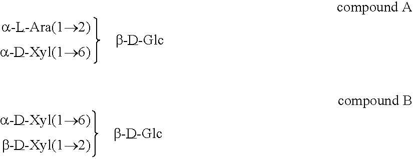
α-L-Ara(1→2)α-D-Xyl(1→6)β-D-Glc compound S

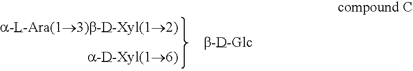

(the processes for obtaining which are more particularly described in Vincken J P, Beldman G, Niessen W M A, Voragen A G J (1996) Carbohydrate Polymers, 29, 1, 75-85)

in which Fuc represents fucose, Gal represents galactose, Glc represents glucose, Ara represents arabinose, and Xyl represents xylose.

The invention also relates to the above-mentioned use of compounds of formula:

X₁-X₂-X₃-(X₄)ₙ

in which n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1,

at least one of X₅, X₆, or X₇ representing a xylose or a fucose.

A more particular subject of the invention is the above-mentioned use of compounds of formula:

X₁-X₂-X₃-(X₄)ₙ

in which n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅ represents a xylose, X₆ represents a galactose, X₇ represents a fucose, and m represents 0 or 1.

Therefore, the invention relates more particularly to the above-mentioned use, of the compounds of the following formulae:

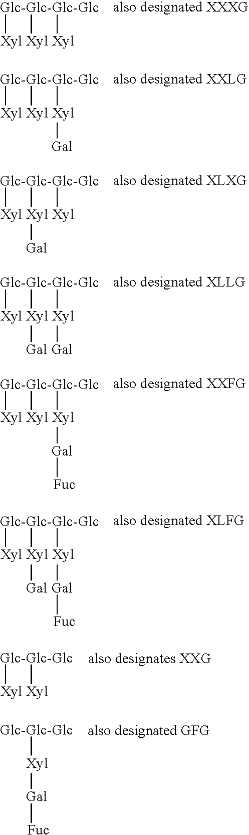

or the compounds designated XL, XLGG, XLXG, LS, AXXG,

(the processes for obtaining which are more particularly described in Mc Dougall G J, Fry S C (1989) Plant Physiol 89, 883-887; Mc Dougall G J, Fry S C (1990) Plant Physiol 93, 1042-1048; Konishi T, Mitsuishi Y, Kato Y (1998) Biosci Biotechnol Biochem, 62.12, 2421-2424; Renard C M G C, Lomax J A, Boon J J (1992) Carbohydrate Research 232, 303-320, for the preparation of the XXFG, XXXG, XLGG oligomers; Vincken J P, Beldman G, Niessen W M A, Voragen A G J (1996) Carbohydrate Polymers, 29, 1, 75-85, for the preparation of the XG, XXG, FG, XLXG oligomers; Spronk B A, Rademaker G J, Haverkamp J, Thomas-Oates J E, Vincken J P, Voragen A G, Kamerling J P, Vliegenthart J F (1997) Carbohydrate Research, 305, 2, 233-242, for the preparation of GFG, GFGGF; and Hantus S, Pauly M, Darvill A G, Albersheim P, York W S (1997) Carbohydrate Research 28, 304, 1, 11-20 for the preparation of the nonasaccharide in which L-Fuc is replaced by L-Gal),

the glucose residue in position X₄ in the formulae of the compounds above, or that in position X₃ in the XXG compound, being optionally in reduced form.

A subject of the invention is also the above-mentioned use of polymers of formula [X₁-X₂-X₃-(X₄)ₙ]_{N} in which:

n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1, at least one of X₅, X₆, or X₇ representing a xylose or a fucose,

N represents an integer comprised between approximately 50 and approximately 300, and preferably comprised between approximately 50 and approximately 100,

or N represents an integer comprised between approximately 2 and approximately 50, and preferably comprised between approximately 2 and approximately 20, in particular between 5 and 12.

A more particular subject of the invention is the above-mentioned use of polymers of formula [X₁-X₂-X₃-(X₄)ₙ]_{N} defined above in which N represents an integer less than or equal to 12, and preferably less than or equal to 5 (namely polymers the degree of polymerization DP of which is less than or equal to 12).

A subject of the invention is also the above-mentioned use of successive chains of at least two units represented by a compound of formula X₁-X₂-X₃-(X₄)ₙ in which n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1, at least one of X₅, X₆, or X₇ representing a xylose or a fucose,

at least one of the units of said chains being such that at least one of the sugars or osidic chains bonded to X₁, X₂, X₃, or X₄, is respectively different from one of the sugars or osidic chains bonded to X₁, X₂, X₃, or X₄, from one or more of the other units of said chains.

A more particular subject of the invention is the above-mentioned use of chains of units as defined above, in which the number of units is less than or equal to 12, preferably less than or equal to 5.

Therefore, the invention relates more particularly to the above-mentioned use of compounds of formula:

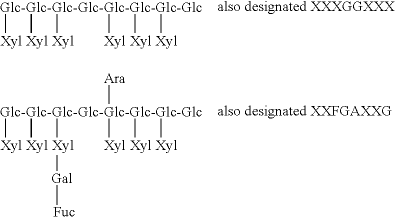

(the processes for obtaining which are more particularly described in: Sims I M, Munro S L A, Currie G, Craik D, Basic A (1996) Carbohydrate Research 293, 147-172 (xylose structure in tobacco), and Vincken J P, Wijsman A J M, Beldman G, Niessen W M A, Voragen A G J (1996) Carbohydrate Research, 288, 219-232, for arabinose structures in potatoes),

the glucose residue at the terminal position in the formulae of the above compounds being optionally in reduced form, and in α or β form,

or also the compounds of formula XXFXXG, XLFGXXXG (Vincken et al. (1996) above-mentioned), XFFGXXXG, XXFGAXXG (Hisamatsu M, York W, Darvill A, Albersheim P (1992) Carbohydr Research, 227, 45-71), GFGGFG (Spronk B A et al. (1997) above-mentioned.

The invention also relates to the above-mentioned use of xyloglucan polymers or oligomers, or of their derivatives as defined above, optionally bonded to other glycans (or forming part of the composition of other glycans), in particular polymers constituting the cell walls of plants or representing the glycan part of glycoproteins, as obtained:

from plants, in particular by extraction from seeds, leaves, roots, fruits, in particular from:

apples (Malus malus L., Rosaceae), in particular according to the method described in Renard C M G C, Renard Lomax J A, Boon J J (1992) Carbohydrate Research 232, 303-320; Vincken J P, Beldman G, Niessen W M A, Voragen A G J (1996) Carbohydrate Polymers, 29, 1, 75-85; Spronk B A, Rademaker G J, Haverkamp J, Thomas-Oates J E, Vincken J P, Voragen A G, Kamerling J P, Vliegenthart J F (1997) Carbohydrate Research, 305, 2, 233-242),

potato tubers, in particular according to the method of Vincken J P, Wilsjman A J, Beldman G, Niessan W M, Voragen A G (1996) Carbohydrate Research, 19, 288, 219-232,

Echinacea, in particular from roots or leaves according to the method described in Wagner H, Jurcic K (1991) Arzneimittelforschung 41(10):1072-6,

or seeds of Tropaeolum majus L. (McDougall G J and Fry S C (1989) Plant Physiol 89, 883-887), or of Hymenaea courbaril L (Buckeridge M S, Crombie H J, Mendes C J, Reid J S, Gidley M J, Vieira C C(1997) Carbohydr Roes 5, 303, 2, 233-7; Vargas-Rechia C, Reicher F, Sierakowski M R, Heyraud A, Driguez H, Lienart Y, (1998) Plant Physiology, 116.1013-1021),

from plant cell suspensions of, in particular Acer, Rosa, Mentha, Nicotiana, Populus, Dioscorea deltoidea, Digitalis lanata, or Echinacea, in particular by extraction from cell walls, or by isolation from the culture medium, in particular according to the methods described in:

Hisamatsu M, York W S, Darvill A G, Albersheim P (1992) Carbohydrate Research 227, 45-71; York W S, Imallomeni G, Hisamatsu M, Albersheim P, Darvill A G (1995) Carbohydrate Research 1, 267, 1, 79-104, concerning Acer,

McDougall G J and Fry S C (1989) Plant Physiol 89, 883-887 and Mc Dougall G J and Fry S C (1991) Carbohydrate Research 219, 123-132, concerning Rosa,

Maruyama K, Goto C, Numata M, Suzuki T, Nakagawa Y, Hoshino T, Uchiyama (1996) Phytochemistry 41(5):1309-14, concerning Mentha,

Sims I M, Munro S L, Currie G, Craik D, Bacic A (1996) Carbohydr Roes 31;293(2):147-72, concerning Nicotiana,

Roesler J, Steinmuller C, Kiderlen A, Emmendorffer A, Wagner H, Lohmann-Matthes M L J (1991) Immunopharmacol. 13 (7), 931-41, concerning Echinaceae,

Hayashi T, Takada T (1994) Biosc. Biotechn Biochem 58, 9, 1707-8, concerning Populus,

from fungi such as Lentinus edodes, Ganoderma lucidum, Schizophyllum commune, Trametes versicolor, Inonotus obliquus, and Flammulina velutipes, in particular by extraction from the mycelium, or by isolation from a culture medium, in particular according to the method described in Wasser S P, Weis A L (1999) Crit Rev Immunol 19(1):65-96,

from seaweed, such as Ulva lactuca, or Ulva rigida, in particular according to the method described in Ray B, M Lahaye (1995), Carbohydrate Research 274, 251-261; Lahaye M, Jegou D, Buleon A (1994), Carbohydrate Research 262, 115-125.

A subject of the invention is also the above-mentioned use of xyloglucan oligomers, or of derivatives as defined above, as obtained:

by chemical or chemoenzymatic synthesis, in particular by endotransglycosylation according to the method described in York W S, Hawkins R Glycobiology (2000) 10, 2, 193-201,

by fermentation of genetically modified or non-modified bacterial strains,

by hydrolysis of polymers containing xyloglucan (or the structural units of xyloglucan), or of glycans representing the glycan part of glycoproteins, using appropriate enzymes such as:

cellulases, and more particularly endo-β-1,4-glucanases of Trichoderma, such as that of Trichoderma viride, or of T. reesei, or that of Aspergillus, such as that of A. niger, and of exo-cellulases of Irpex lacteus, these enzymes being extraction or recombinant enzymes, in particular according to the isolation methods using extraction endoglucanases described in Renard C M G C, Searle-can Leewen M J F, Voragen A G J, Thibault J F, Pilnik W (1991) Carbohydrate Polymers 14, 295-314; Renard C M G C, Searle-can Leewen M J F, Voragen A G J, Thibault J F, Pilnik W (1991) Carbohydrate Polymers 15, 13-32; or according to the isolation methods using extraction cellobiohydrolases described in Amano Y, Shiroishi M, Nisizawa K, Hoshino E, Kanda T (1996) J Biochem (Tokyo) 120 (6):1123-9; or according to the methods using recombinant endoglucanases described in Pauly M, Andersen L N, Kauppinen S, Kofod L V, York W S, Albersheim P, Darvill A (1999) Glycobiology 9 (1) 93-100, or using other endoglucanases (E.C. 3.2.1.4) of the GH 12 family (according to “IUB-MB Enzyme nomenclature”), in particular of the organisms Aspergillus aculeatus, Thermotoga maritima and Thermotoga neapolitana obtained by recombinant route,

glycosidases such as β-D-glucosidase, α-L-fucosidase, α-L-xylosidase, β-D-xylosidase, α-D-fucosidase, these enzymes being extraction or recombinant enzymes, in particular according to the method described in York W S, Harvey L K, Guillen R, Alberheim P, Darville A (1993) Carbohydrate Research, 248, 285-301,

said enzymatic treatment being followed by several stages of purification of the xyloglucan oligomers obtained, in particular by chromatography according to the method described in Mc Dougall G J, Fry S C (1990) Plant Physiol 93, 1042-1048;

Hisamatsu M, York W S, Darvill A G, Albersheim P (1992) Carbohydrate Research 227, 45-71.

A subject of the invention is also a process for the stimulation of glutathione reductase in plants, characterized in that it comprises a stage of plant treatment with at least one compound defined above, in particular by irrigation of the soil on which these plants are cultivated, with a composition comprising said compound, or by coating the seeds with such a composition, or by foliar spraying of such a composition in the field on the plants to be treated.

The invention relates more particularly to the use of the above-mentioned process, for the implementation of a process for adaptation of the plants to an abiotic stress, such as adaptation to the cold, or to a hydric stress such as drought, humidity or salinity.

A subject of the invention is also a process for the stimulation of phospholipase D production in plants, characterized in that it comprises a stage of plant treatment with at least one compound defined above, in particular in the manner indicated above.

A more particular subject of the invention is the use of the above-mentioned process, for the implementation of a process for the control of flowering, and more particularly a process for the control of floral induction, of flowering duration, and of flower abscission, and/or for implementation of a process for the control of plant fructification, and more particularly of a process for the control of the triggering and duration of fruit maturation, of leaf and fruit abscission.

A subject of the invention is also a process for stimulation of the production of glycosylhydrolases in plants, characterized in that it comprises a stage of plant treatment with at least one compound defined above, in particular in the manner indicated above.

A more particular subject of the invention is the use of the above-mentioned process, for the implementation of a process for the induction of defence reactions against pathogens, such as bacteria, viruses, fungi, and/or control of certain plant development phases (germination, fertilization, cell differentiation during flowering or fructification).

Advantageously, the above-mentioned compositions comprising at least one compound defined above and used within the scope of the present invention, are presented as agricultural inputs in solid form (in particular powder, granules, pellets), or in liquid form (in particular in aqueous solution), combined or not combined with other agricultural input compounds.

Of the plants capable of being treated within the scope of the present invention, agronomically useful plants, such as the vine, fruit trees (in particular apple, pear, walnut), cereals (in particular rice, barley), oleaginaceous plants (in particular soya, rape, sunflower), protein plants (in particular peas), and market garden crops (in particular tomatoes) can chiefly be mentioned.

The invention is further illustrated using the following detailed description of the effects of compounds according to the invention on the stimulation of glutathione reductase, and of phospholipase D, as well as on other systems linked to these enzymes.

I) Elicitation of an “Oxidative Burst”: Generation of H₂O₂

Methodology

Preparation of Rubus fruticosus protoplasts according to Vargas-Rechia (1998). The protoplast yield is of the order of 70 to 85% of the initial number of cells used; the viability of the protoplasts, of the order of 90 to 95%, was checked using Evans blue indicator.

H₂O₂ assay according to Apostol et al. (1989). Incubation at different temperatures of 1.10⁶ protoplasts in microplate wells in the presence of 2 μM pyranine λₑₓ 405 nm, λ_{cm} 512 nm), of the elicitor (0 to 100 μM): 2′-fucosyl-lactose (compound A), xyloglucan XXFGol, corresponding to the reduced form of fucosylated nonasaccharide of which the sugar X₄ is in reduced form (compound B). The variations in pyranine fluorescence (ΔF₅₁₂ min⁻¹) allow H₂O₂ assay. The results are shown in FIG. 1.

Evaluation of the experimental data: The reaction rate is given by (ΔF₅₁₂ min⁻¹). At least three kinetic curves are plotted per sample and per experimental condition. One point on the graph corresponds to the slope of the regression curve deduced from at least 6 kinetic curves.

Results

Generation of H₂O₂: Detection and Characterization of the Elicitation Response

The oxidative “burst” is evaluated according to the “quenching ” of the pyranine at 25° C.; the 100% reference value corresponds to the fluorescence in the controls (non-elicited protoplast suspensions)

a) Effect of the elicitor dose (FIG. 1)

Optimal response at:

10 nM (225%) for compound A

15 nM (175%) for compound B

2′-fucosyl lactose as a signal inducing an oxidant burst is more efficient than the xyloglucan oligomer. On the other hand, the optimal doses for both products are very close.

b) Effect of Temperature on Peroxide Accumulation (FIG. 2A, FIG. 2B)

The peroxide accumulation induced by the signal 2′-fucosyl lactose (used at the optimal dose of 10 nM) is lower at a low temperature.

II) Elicitation of an “Oxidative Burst ”: Generation of Superoxide Anion.

Methodology

Preparation of Rubus fruticosus protoplasts according to Vargas-Rechia (1998). The protoplast yield is of the order of 70 to 85% of the initial number of cells used; the viability of the protoplasts, of the order of 90 to 95%, was checked using Evans blue indicator.

The Cyt c assay was carried out according to Nakanishi et al. (1991) in the following manner. Incubation at 25° C. of 4.10⁶ protoplasts in the presence of Cyt c (100 μM), and of the elicitor (0 to 100 μM): 2′-fucosyl lactose (compound A), XXFGol (compound B). The results are shown in FIG. 3.

Evaluation of the experimental data: The reaction rate is given by (AF₃₄₀ min⁻¹). At least three kinetic curves are plotted per experimental condition. One point on the graph corresponds to the slope of the regression curve deduced from at least 6 kinetic curves.

Results

Reduction of the Cytochrome c: Detection and Characterization of the Elicitation Response

The elicitation response is evaluated according to the cytochrome c reduction measured by the absorbance variation at 340 nm; the 100% reference value corresponds to the reduction count of the controls (non-elicited protoplast suspensions).

FIG. 3 shows that the response is optimal at:

50 nM (200%) for compound A (2′-fucosyl lactose)

15 nM (159%) for compound B (XXFGol)

2′-fucosyl lactose as a signal inducing an oxidative “burst” is more efficient than the xyloglucan oligomer (187% instead of 160% at 10 nM). On the other hand, the optimal dose of 2′-fucosyl lactose is 50 nM compared with 15 nM for the xyloglucan oligomer.

III) Adaptation Response to Oxidant Stress: Elicitation of Glutathione-Reductase Activity

Methodology

Preparation of Rubus fruticosus L. protoplasts according to Vargas-Rechia et al. (1998). The protoplast yield is of the order of 70 to 85% of the initial number of cells used; the viability of the protoplasts, of the order of 90 to 95%, was checked using Evans blue indicator.

Glutathione-reductase (GR) activity assay according to Jahnke L S et al. (1991):

GSSG (glutathione in oxidized form) is reduced to GSH (glutathione in reduced form) by the enzyme glutathione-reductase (EC 1.6. 4.2); the reaction is coupled with the oxidation of NADPH to NADP in the catalytic cycle (glutathione, glutathione-reductase, NADPH). The glutathione-reductase activity is measured by evaluating the formation of NADP in the medium, which is carried out by monitoring the absorbance reduction at 340 nm.

Test: 4.10⁶ protoplasts in 1 ml of Tris-HCl buffer (pH 4.8) are incubated at 10° C., 15° C., 25° C. in the presence of the elicitor (0 to 100 μM): 2′-fucosyl lactose (compound A), xyloglucan XXFGol (compound B). After interaction for 10 minutes, an enzymatic extract is prepared according to Jahnke et al. (1991), and a 16.000 g aliquot of the supernatant (equivalent to 1 μg of proteins) is introduced into the pH 7.8 reaction medium (80 mM K₂PO₄, 500 μM GSSG, 150 μM NADPH, 200 μM DTPA) for the glutathione-reductase activity assay; the A₃₄₀ recording is carried out for 1 minute using a Beckman D U 640 spectrophotometer. The results for compound A are shown in FIG. 4.

Evaluation of the experimental data: The reaction rate is given by ΔA₃₄₀ min⁻¹. At least three kinetic curves are plotted per experimental condition and per sample. One point on the graph corresponds to the value of the slope of the regression curve deduced from at least 6 kinetic curves.

Results:

Induction of Glutathion Reductase Activity by the Elicitor 2′-Fucosyl Lactose (A)

The elicitation response is evaluated by measuring the formation of NADP at 340 nm. The 100% reference value corresponds to the NADP content in the controls (non-elicited protoplast suspensions).

FIG. 4 shows that the elicitation response, which is dose-dependent, is optimal at

25 nM (2500%) for compound A (2′-fucosyl lactose) used at 10° C.

100 nM (780%) for compound A (2′-fucosyl lactose) used at 15° C. whilst no significant response is obtained at 25° C. Moreover, compound B (XXFGol) gives similar results (not represented).

### BIBLIOGRAPHICAL REFERENCES OF THE METHODS USED IN PARAGRAPHS I TO III ABOVE

Vargas-Rechia, C., F. Reicher, M. Rita Sierakowski, A. Heyraud, H. Driguez, Y. Lienart (1998) Plant Physiol. 116, 1013-1021.

Apostol, I., P. F. Heinstein, P. S Low (1989) Plant Physiol. 90, 109-116.

Nakanishi, M., H. Takihara, Y. Minoru, K. Yagawa (1991) FEBS Letters 282: 91-94.

Jahnke L S, Hull M R, Long S P (1991) Plant Cell Environment 14, 97-104.

IV) Induction of a Thiol-Protease Inhibitor

Methodology

Vegetable Material: Acer pseudoplatanus L. Cells in Suspension

Test: 2.10⁶ cells of Acer pseudoplatanus L. were elicited by 50 nM of 2′-fucosyl lactose (compound A) or by 50 nM of methyl α-L-Fuc (1→2)β-D-Gal (1→2)β-D-Xyl trisaccharide (compound B) (synthesized according to Lopez et al., 1994) for 30 minutes or for 42 hours. Inhibitors of protease (IP) were prepared according to the protocol of Walker-Simmons (1977) starting from elicited or non-elicited cells. It was verified that the viability of the cells was maintained at more than 85% for the whole duration of the experiment.

Papain activity assay: the reaction medium contains an aliquot of IP extract (equivalent to 1 or 2 μg of proteins) in sodium phosphate citrate buffer (0.1M) pH 6 enriched with cysteine-HCl (5 mM), papain (EC 3.4.22.2) (0.48 units), p-nitroanilide N-α-benzoyl-D-L-arginine (BAPNA) (0.27 mM). The activity assay is based on the absorbance measurement at 410 nm. The reaction rate is given by ΔA₄₁₀ min⁻¹.

Evaluation of the experimental data: for a given sample, the activity of an IP inhibitor isolated from this sample is estimated by developing the protease kinetics (recording at 410 nm for IO minutes in the presence or not in the presence of a variable quantity of inhibitor). The experimental conditions adopted (incubation time, substrate, enzyme and IP extract concentrations) are those which lead to linear and reproducible kinetics. The initial reaction rate is the slope α(A₄₁₀ minutes⁻¹) of a curve A₄₁₀=f(t). For a given sample, at least three curves are plotted and the initial rate is deduced by linear regression. The protease activity modulation capacity is expressed as a % of the control activity (protease activity without IP inhibitor).

Results

Induction of a Papain Inhibitor by the Elicitor 2′-Fucosyl Lactose (A) or Methyl α-L-Fuc (1→2)β-D-Gal (1→2)β-D-Xyl (compound B)

The elicitation response is evaluated according to the papain inhibition measured in the presence of a protease inhibitor prepared from cells elicited by 2′ fucosyl lactose (2A) or by methyl α-L-Fuc (12) β-D-Gal (12) β-D-Xyl trisaccharide (2B); the results are expressed as a % of the control activity (papain activity in the non-elicited cells measured without inhibitor).

FIG. 5 shows that the response of the cells varies with the time of interaction with the elicitor oligosaccharide. For an early reaction (after 30 minutes of use of the elicitor), 2′-fucosyl-lactose and the trisaccharide develop the same papain inhibitor potential (thiol-protease activity, protease activity dependent on SH group). A potential inhibitor but one of lower intensity is expressed within the scope of a late reaction (after 42 hours of use of the elicitor).

### BIBLIOGRAPHICAL REFERENCES WITH RESPECT TO THE METHODOLOGY

Walker-Simmons, M., and Ryan, C. A. (1977) Plant Physiol. 59, 437-439.

Lopez R, Montero E, Sanchez J, Canada A, Fernnandez-Mayoralas A, (1994) J. Org. Chem 59, 7027-7032.

V) Elicitation of a Hydrolase Glycosyl Activity

The elicitation responses identified relate to:

the induction of a glycosidase activity, i.e. the a) β-D-xylosidase (EC 3.2.1.37) response,

the induction of a glycanase activity, i.e. the b) 1,4 β-D-glucanase (EC 3.2.1.4), c) 1,3 β-D-glucanase (EC 3.2.1.39), and d) endochitinase (EC 3.2.1.14) responses.

Methodology

Vegetable material: Acer pseudoplatanus L Cells in Suspension

Test: 2.10⁶ Acer pseudoplatanus L. cells were elicited under circular stirring (80 rpm), in 25 ml of culture medium (without 2,4-D) by 50 nM of 2′-fucosyl lactose (compound A) or 50 nM of methyl α-L-Fuc (1→2) β-D-Gal (1→2) β-D-Xyl trisaccharide (compound B)(synthesized according to Lopez et al., 1994) or for a variable time (0 to 42 hours) in the presence or not in the presence of an effector: cycloheximide (1 μM), okadaic acid (5 nM), staurosporine (500 nM), or boroglycine (500 nM). The elicitation experiment is stopped by putting the cells in ice. The cells recovered after decantation and taken up in approximately 1 ml of elicitation buffer are the subject of a specific protein extraction.

D-glycosylhydrolase extraction. The enzyme extracts are prepared from elicited or non-elicited cells. The cells are homogenized at 0° C. in Tris-HCl buffer (50 mM pH 7.2) containing 1 M of NaCl with a Vibracell™ Bioblock sonicator, maximum power, for 3 times 1 minute. The homogenates are centrifuged at 4° C. (12000 g, 15 minutes) then dialysed and concentrated on Ultrafree™ Millipore ultrafiltration units (cut-off threshold 10 kDa). The retentates, taken up in distilled water, are crude extracts.

β-D-xylosidase activity assay according to the protocol of Lee and Zeikus (1993) after incubation of the enzyme extracts (2 to 4 μg of proteins) in sodium acetate buffer (0.1 M, pH 5), at 40° C. for a variable time (90 to 210 minutes), in the presence of p-nitrophenyl β-D-xylopyranoside (p-NPX) substrate (7.3 μM). After addition of Na₂CO₃ (0.1 M), the products released are assayed by spectrophotometry at 410 nm.

1,3 β-D-glucanase activity assay. This is based on colorimetric assay (ferricyanide test of Kidby and Davidson (1973) of the substrate reducing units (laminarin or laminarin hexamer) released during the hydrolysis. The reaction medium contains the enzyme extract (1 μg of proteins), the substrate (5 μM of reduced laminarin hexamer) in 100 μl of sodium acetate buffer (0.1 M), pH 5.0); the enzymatic reaction at 40° C. develops over a variable time (1 to 3 hours).

1,4 β-D-glucanase activity assay. This is based on colorimetric assay (ferricyanide test of Kidby and Davidson (1973) of the cellopentaose substrate reducing units released during the hydrolysis. The reaction medium contains the enzyme extract (1 μg of proteins), reduced cellopentaose (4 μM) in 100 μl of sodium acetate buffer (0.1 M), pH 5.0); the enzymatic reaction at 40° C. develops over a variable time (1 to 3 hours).

Endochitinase activity assay. This is based on the released reducing sugar assay according to Somogyi (1952). The reaction medium contains the enzyme extract (1 μg of proteins), the substrate (25 μg of chitin) in 100 μl of sodium acetate buffer (0.1 M), pH 5.0; the enzymatic reaction at 40° C. develops over a variable time (1 to 5 hours).

Evaluation of the experimental data. At least 2 kinetics were carried out per sample, and per set of experiments. The reaction rate (ΔA₄₁₀ minutes⁻¹ for example) is obtained by linear regression from 4 kinetic curves. The results are expressed by the ratio R (enzymatic activity in elicited cells/enzymatic activity in non-elicited control cells).

Results:

a) Induction of a β-D-xylosidase response. The early β-D-xylosidase response is transitory; it is maximal from 15 minutes (R=9 for compound A and R=5 for compound B); and it disappears after 1 hour: R=1). For an elicitor treatment duration of 42 hours, no significant response is observed.

b) Induction of a 1,4 β-D-glucanase response. The early response is transitory (R of the order of 5 after 20 minutes for each elicitor A or B). For an elicitor treatment duration of 42 hours, the response R is of the order of 4.

c) Induction of a 1, 3 β-D-glucanase response. The early response is transitory (R of the order of 3 after 20 minutes for each elicitor, A or B). For an elicitor treatment duration of 42 hours, the response R, which is very high, is of the order of 12.

d) Induction of an endochitinase response. The early response is transitory (R of the order of 6 after approximately 25 minutes for each elicitor, A or B). For an elicitor treatment of 42 hours, no enzymatic activation was detected.

It is noted that in the presence of a protein synthesis inhibitor (cycloheximide), all the early responses are maintained whereas the late responses are reduced with a value of R of the order of 2 (for 1,4 β-D-glucanase activity) or 3 (for 1,3 β-D-glucanase activity). Conversely, the early responses (with the exception of 1,3 β-D-glucanase activity) are modulated by a post-transcriptional effector such as boroglycine or okadaic acid whereas the late responses are not affected.

### BIBLIOGRAPHICAL REFERENCES WITH RESPECT TO THE METHODOLOGY MENTIONED IN PARAGRAPH V

Lopez R, Montero E, Sanchez F, Canada J, Fernandez-Mayorales A (1994). J. Org. Chem. 59, 7027-7032.

Lee Y. E and Zeikus J. G (1993) J. Gen. Microbiol. 139, 1235-1246

Somogyi M. (1952). J. Biol. Chem. 195, 19-23.

Kidby D E and Davidson D J (1973) Anal Biochem, 55.321-325

VI) Elicitation of a Phospholipase D Activity

Methodology

Vegetable material: Acer pseudoplatanus L. cells in Suspension

Phospholipase D (E.C: 3.1.4.4) (Plase D) activity: this is a phosphatidylcholine phosphatidohydrolase which releases the O-R3 group, according to the diagram below. To the extent that O-R3 is marked (a fluorochrome for example), quantifying this group is equivalent to assaying Plase D activity. For the experiments the substrate used is phosphatidylcholine conjugated to a fluorochrome, i.e. the product nitrobenzoxadiazole phosphoethanolamine (NBD-PE). The retained excitation and emission wavelengths of the fluorochrome are 460 nm and 534 nm respectively.

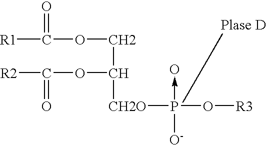

R1: CH₃(CH₂)₁₄

R2: CH₃(CH₂)₁₄

R3:—CH₂—CH₂—NH₂

Principle: assaying Plase D activity is equivalent to estimating the fluorescence variation at 534 nm of a reaction medium with a spectrofluorimeter (Perkin Elmer).

Test: the reaction medium in a microtitration plate well is as follows: 1.3 10⁷ Acer pseudoplatanus L. cells are incubated in a 50 mM HEPES buffer, pH 6.8 enriched with CaCl₂ (1 μM), ATP (2 μM), octyl-D-glucoside 50 μM, GTP (6 μM) in the presence of the NBD-PE substrate (4 μM), in the presence or absence of an elicitor (0-100 nM): 2′-fucosyl-lactose (FL), compound A; XXFGol, compound B, in the presence or not in the presence of a methyl jasmonate effector (0-5 nM). The Plase D activity assay is carried out by measuring the fluorescence at 534 nm.

Evaluation of the experimental data. For each sample at least three kinetics are recorded; the Plase D activity is given by the slope of the regression curve. The results are expressed by Δ F₅₃₄ min⁻¹. One point on the graph corresponds to the linear regression treatment of at least 2 kinetic curves originating from 2 different samples.

Results:

Induction of Plase D Activity by the elicitor 2′-fucosyl lactose (A) or by the xyloglucan XXFGol (B).

The Plase D elicitation response is evaluated according to the fluorescence variation at 512 nm; the 100% reference value corresponds to the fluorescence in the controls (non-elicited cells)

a) Effect of the elicitor dose. FIG. 6 shows that 2′-fucosyl lactose and the oligomer XXFGol are Plase D activity elicitors. The response is optimal for a very low elicitor concentration, i.e. 1 nM (244%) for 2′-fucosyl lactose (A) and 1.7 nM (230%) for XXFGol (B).

b) Antagonistic effect of methyl jasmonate. FIG. 7 shows that methyl jasmonate (from 0 to 5 nM) and 2′-fucosyl lactose (A) (1 nm) are antagonistic, and that this response is dose-dependent.

VII) Study of the Elicitor Potential of Xyloglucan or Derivative in the Vine: Effect of Inducing Cold-Resistance

### EXAMPLE 1

### Identification of the Elicitor Effect of Xyloglucan or Derivative

Experimental Conditions:

Plants originating from different vine varieties (Chenin, Grolleau, Carignan, Cabernet sauvignon, Cabernet Sauvignon, Pinot noir, Merlot, Chardonnay, Gamay etc.) are used for the study. Each sample, comprising 5 to 10 plants, is treated with foliar spraying at the end of the bud development (starting from vegetative stage 7 on the BBCH scale), or during the inflorescence development period (starting from vegetative stage 12) or at the start of flowering (as from stage 19), with the elicitor (oligomer: XXFG; derivative: 2′-fucosyl lactose) in solution at a variable dose (0.03 mg/l ≦dose≦3.3 mg/l; the spraying of 2.5 ml of solution per plant is carried out using a hand sprayer (deviation of +/−1%).

After treatment, the plants are exposed to cold stress of variable duration and intensity (for example, temperature varying from −2° C. to −5° C.; duration less than or equal to 240 minutes).

After exposure to the cold, the plants are placed in a climatic chamber at 20° C. with a 12-hour day/night alternation. The appearance of the leaves is observed 3 hours, 24 hours, 48 hours, 72 hours after removal from the cold. The effects of the cold are evaluated by observing the foliar necroses induced by frost and the plants are kept for several months in order to monitor their subsequent development.

The proportion P (%) of foliar necroses observed 3 hours or 24 hours or 48 hours or 72 hours after the cold stress is counted, and the results are expressed by the protection index I=(100-P) %.

Results: Summary Table for the Plants of the Vine Variety Chenin.

The results relating to the control plants (A) treated with water and the plants elicited by XXFG at dose d, d/10, d/50, d/100 (d=3.3 mg/l)(B) are expressed by the cold protection index I=(100-P) %, P being the proportion (%) of foliar necroses observed 12 hours after the stress.

| Stress | −2° C. | −3° C. | −4° C. | −5° C. |
|---|---|---|---|---|
| Cold | 240 minutes | 240 minutes | 110 minutes | 120 minutes |
| A (index %) | 20 | 0 | 0 | 0 |
| B (index %) | | | | |
| d | 100 | 100 | 100 | 100 |
| d/10 | 100 | 100 | 100 | 100 |
| d/50 | 100 | 100 | 90 | 75 |
| d/100 | 80 | 65 | 55 | 40 |

The plants treated by XXFG at a dose of 3.3 mg/l resist cold stress levels which destroy the leaves of the controls treated with water: the coloration of the leaves of the elicited plants remains normal instead of turning dark green immediately after thawing (as observed for the controls treated with water), and no sign of necrosis appears after 12 hours as observed for the controls treated with water). It was noted that the use of the elicitor does not disturb the plant's development, given that the development of the elicited plants after the cold stress is comparable to that of the control plants not exposed to the cold.

The table also shows that elicitor solutions diluted to 1/10, 1/50 and 1/100 are capable, but sometimes with lower efficiency, of inducing the vine's cold resistance.

Moreover, it was noted that:

the use of a xyloglucan derivative such as the compound 2′-fucosyl lactose is capable of reproducing the cold-resistance-inducer effect, with an equal or slightly lower efficiency;

the elicitor is active on all the vine varieties tested but each vine variety has a specific sensitivity; for example, the vine varieties Pinot noir and Chenin are vine varieties which are highly receptive to an elicitor treatment.

### EXAMPLE 2

### Frost Resistance Varies According to Elicitor Dose

Chenin plants were elicited by XXFG used at variable doses: d, d/10, d/50, d/100 (d=3.3 mg/l) before being exposed to −3° C. for a variable time (a: 165 minutes, b: 195 minutes, c: 210 minutes, d: 225 minutes).

FIG. 8 shows the results obtained and expressed by the cold protection index I=(100-P) %, P being the proportion (%) of foliar necroses observed 24 hours after the stress.

The elicitation response varies according to the elicitor dose, and the effectiveness of a given solution is different according to the intensity of the cold stress.

The response curves reveal 2 types of response according to the intensity of the stress: for a low stress, the resistance-stimulating effect increases with the dose in order to reach a plateau (curves a and b). Conversely, for a high-intensity stress, an optimal response dose is observed, beyond which the elicitor effect is reduced (curves c and d). It was observed that the use of 2′-fucosyl lactose leads to similar response curves.

### LEGENDS TO FIGURES

FIG. 1: Generation of H₂O₂ triggered by the use of the elicitor A (2′-fucosyl lactose; curve marked by squares) or B (xyloglucan XXFGol; curve marked by circles). The reaction rate, i.e. ΔF₅₁₂ min⁻¹, was evaluated according to the “quenching” of the pyranine recorded for 15 minutes. The elicitor concentration is indicated on the abscissa, and the fluorescence intensity is indicated on the ordinate.

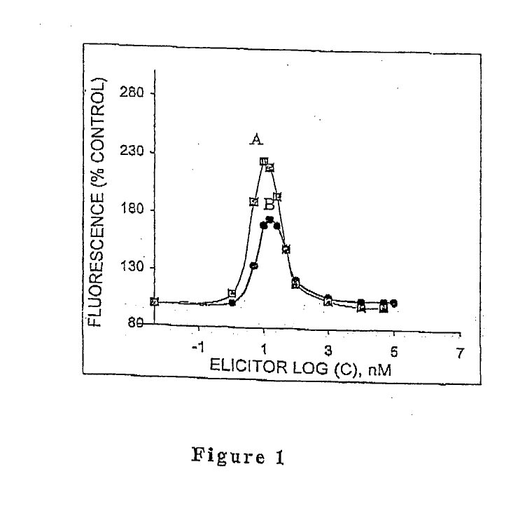

FIG. 2: Generation of H₂O₂ triggered by the use of the elicitor A (2′-fucosyl lactose, 10 nM). The reaction rate, i.e. ΔF₅₁₂ min⁻¹, was evaluated according to the “quenching” of the pyranine recorded for 20 minutes at 25° C., 20° C., 15° C., 10° C. (A): kinetic curves: the time is indicated on the abscissa, and the fluorescence intensity is indicated on the ordinate: each curve illustrates the result obtained at a given temperature; (B) variation of the optimal response according to the temperature: the temperature is indicated on the abscissa, and the production of H₂O₂ at 25° C. is indicated on the ordinate; 100% corresponds to the maximal production of H₂O₂ at 25° C.

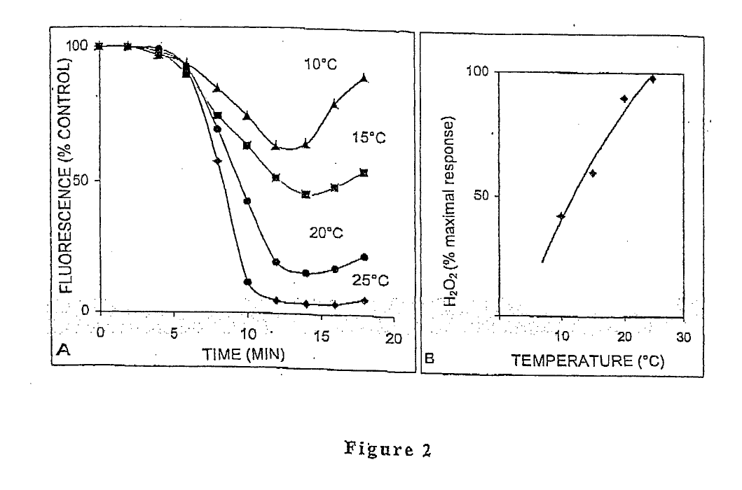

FIG. 3: Generation of superoxide anion triggered by the use of the elicitor A (2′-fucosyl lactose; curve marked by squares) or B (xyloglucan XXFGol; curve marked by diamonds). The cytochrome reduction rate corresponds to ΔA₃₄₀ min⁻¹. The elicitor concentration is indicated on the abscissa, and the reduced cytochrome c content is indicated on the ordinate.

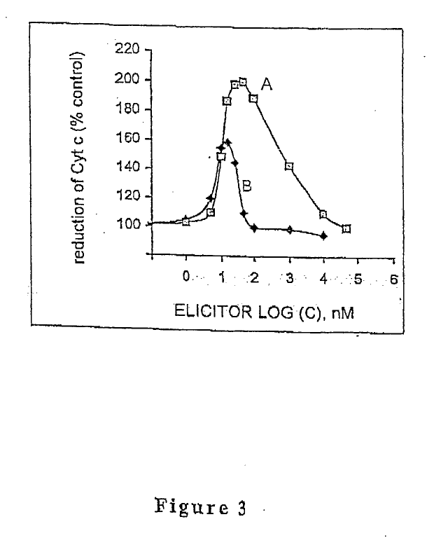

FIG. 4: Elicitation of the glutathione reductase activity induced by the use of the elicitor A (2′-fucosyl lactose). The elicitation reaction rate, i.e. AA₃₄₀ min⁻¹, is measured at 10° C. (curve marked by squares), 15° C. (curve marked by diamonds), and 25° C. (curve marked by circles).

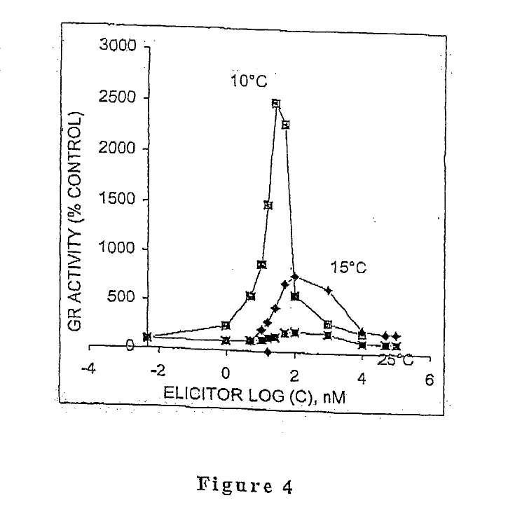

FIG. 5: Evaluation of papain inhibitor activity in cells elicited by 2′-fucosyl lactose used at 50 nM for 30 minutes or for 42 hours (2A) or by methyl α-L-Fuc (1→2) β-D-Gal (1→2) β-D-Xyl trisaccharide used at 50 nM for 30 minutes or for 42 hours (2B) or in non-elicited cells (1). The reaction rate, i.e. ΔA₄₁₀ min⁻¹, is expressed as a % of the papain activity without an inhibitor.

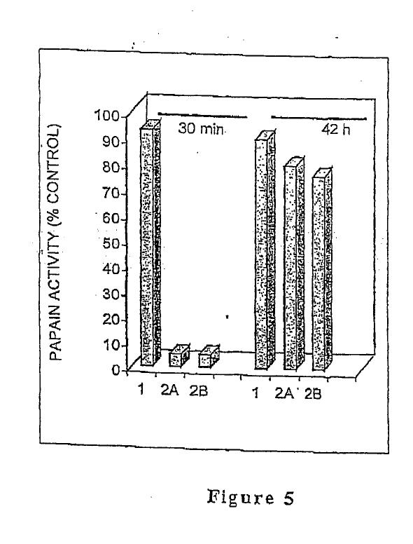

FIG. 6: Elicitation of Plase D activity triggered by the use of the elicitor A (2′-fucosyl lactose; curve marked by squares) or B (xyloglucan XXFGol; curve marked by diamonds). The reaction rate, i.e. ΔF₅₁₂ min⁻¹, is expressed as a % of the Plase D activity in the controls (non-elicited cells).

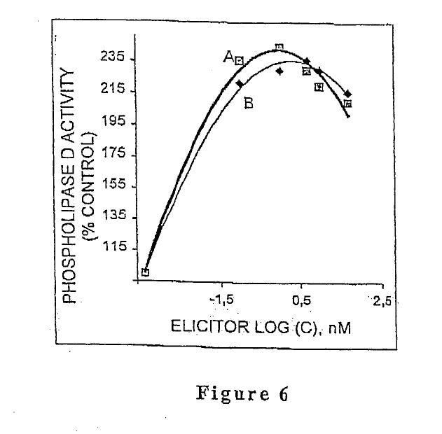

FIG. 7: Elicitation of Plase D activity triggered by the use of the elicitor A (2′-fucosyl lactose) used at the optimal concentration of 1 nM in the presence of methyl jasmonate. The reaction rate, i.e. ΔF₅₁₂ min⁻¹, is expressed as a % of the Plase D activity in the controls (non-elicited cells).

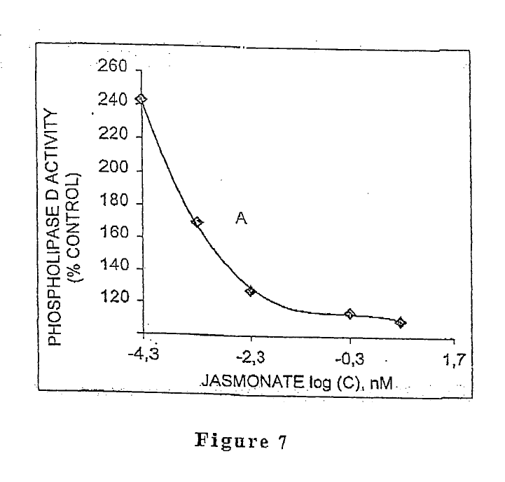

FIG. 8: Protection against the cold of Chenin plants elicited by XXFG used at variable doses: d, d/10, d/50, d/100 (d=3.3 mg/l) before being exposed to −3° C. for a variable time (a: 165 minutes, b: 195 minutes, c: 210 minutes, d: 225 minutes); the results obtained are expressed by the cold protection index I=(100-P) %, P being the proportion (%) of foliar necroses observed 24 hours after the stress.

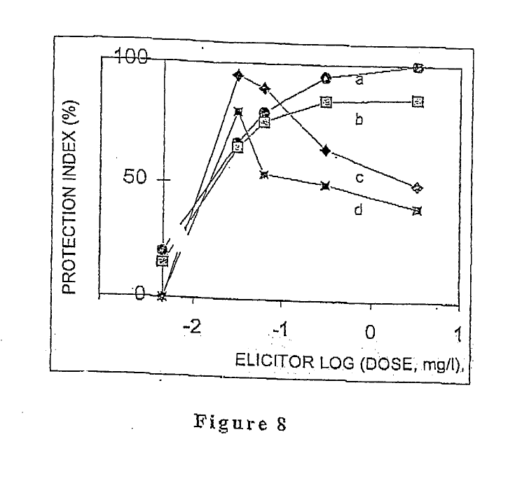

1. Use of a compound comprising an osidic structure of formula:
X₁-X₂-X₃-(X₄)ₙ
in which X₁, X₂, X₃, and X₄, independently from one another, represent a sugar chosen from glucose, galactose, xylose, fucose, or arabinose, this sugar being optionally in reduced form and/or being substituted, in particular by an alkyl or acyl group, such as a methyl or acetyl group, and n represents 0 or 1,
X₁, X₂, X₃, and X₄, independently from one another, being optionally substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1,
at least one of X₁, X₂, X₃, or X₄, or, optionally, of X₅, X₆, or X₇ representing a xylose or a fucose,
or of a compound derived from those defined above, in particular by modification or substitution of one or more above-mentioned sugars, said compounds and their derivatives having the property:
of stimulating glutathione reductase,
and/or of stimulating phospholipase D in plants,
and/or of stimulating glycosyl hydrolases,
within the scope of uses linked to the above-mentioned properties of said compounds, namely:
the adaptation of plants to an abiotic stress, such as adaptation to the cold, or to a hydric stress such as drought, humidity or salinity,
the control of flowering,
the control of fructification,
the induction of defence reactions against pathogens such as bacteria, viruses, fungi.

2. Use according to claim 1, of compounds in which the sugars are in α or β form, optionally in the pyranose or furanose form, and are interconnected by bonds of the 1→2, 1→3, 1→4, or 1→6 type.

3. Use according to claim 1 or 2, of compounds of formula:
X₁-X₂-X₃-(X₄)ₙ
in which X₁, X₂, X₃, and X₄, independently from one another, represent a sugar chosen from glucose, galactose, xylose, fucose, or arabinose, and n represents 0 or 1, at least one of X₁, X₂, X₃, or X₄, representing a xylose or a fucose.

4. Use according to claim 3:
of compounds of formula:
X₁-X₂-X₃-(X₄)ₙ
in which:
X₁ represents a fucose,
X₂ represents a galactose,
X₃ represents xylose or glucose,
X₄ represents a glucose, optionally substituted by a sugar such as glucose,
each of X₁, X₂, X₃, and X₄ being (L) or (D) glycosyl residues in α or β form, and n represents 0 or 1,
and n represents 0 or 1,
X₁, X₂, X₃, and X₄, being optionally substituted, in particular by an alkyl group, such as a methyl group, such as the compounds of formula:
α-D-Fuc(1→2)β-D-Gal(1→2)α-D-Xyl
α-D-Fuc(1→2)β-D-Gal(1→4)β-D-Glc, or 2′-fucosyl lactose
methyl(α-D-Fuc(1→2)β-D-Gal(1→2)β-D-Xyl)
methyl(α-L-Fuc(1→2)β-D-Gal(1→2)α-D-Xyl)
α-D-Fuc(1→2)β-D-Gal(1→2)α-D-Xyl(1→6)β-D-Glc
α-L-Fuc(1→2)β-D-Gal(1→2)β-D-Xyl(1→6)β-D-Glc
α-L-Fuc(1→2)β-D-Gal(1→2)α-D-Xyl(1→6)β-D-Glc(1→4)β-D-Glc, also designated FG,
the osidic residue in position X₃ when n=0, or in position X₄, or substituting that in position X₄, in the formulae of the compounds above, being optionally in reduced form,
or of compounds of formula:
(α-D-Gal(1→2)β-D-Xyl(1→6)β-D-Glc(1→4)β-D-Glc also designated LG
α-D-Xyl(1→2)β-D-Gal(1→2)β-D-Xyl
α-D-Xyl(1→6)β-D-Glc(1→4)β-D-Glc also designated XG
β-D-Xyl(1→4)β-D-Glc(1→4)β-D-Glc
α-D-Xyl(1→2)β-D-Glc(1→4)β-D-Glc
β-L-Ara(1→3)α-L-Ara(1→2)α-D-Xyl compound T 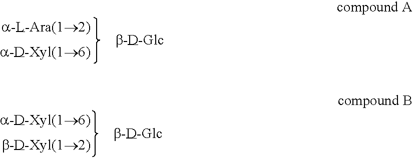
α-L-Ara(1→2)α-D-Xyl(1→6)β-D-Glc compound S 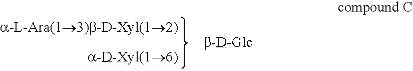
in which Fuc represents fucose, Gal represents galactose, Glc represents glucose, Ara represents arabinose, and Xyl represents xylose.

5. Use according to claim 1 or 2, of compounds of formula:
X₁-X₂-X₃-(X₄)ₙ
in which n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1,
at least one of X₅, X₆, or X₇ representing a xylose or a fucose.

6. Use according to claim 5, of compounds of formula:
X₁-X₂-X₃-(X₄)ₙ
in which n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅ represents a xylose, X₆ represents a galactose, X₇ represents a fucose, and m represents 0 or 1.

7. Use according to claim 5 or 6, of compounds of formulae: 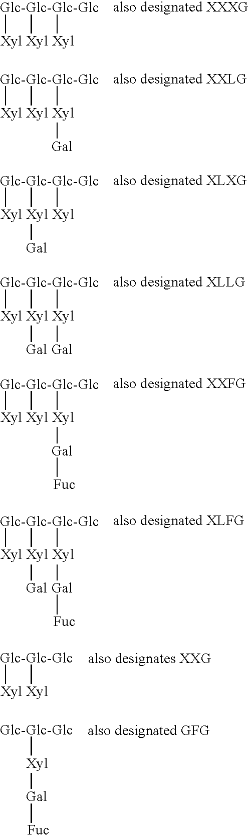
or the compounds designated XL, XLGG, XLXG, LS, AXXG,
the glucose residue in position X₄ in the formulae of the compounds above, or that in position X₃ in the compound XXG, being optionally in reduced form.

8. Use according to claim 1 or 2, of polymers or of oligomers of formula [X₁-X₂-X₃-(X₄)ₙ]_{N} in which:
n represents 0 or 1, X₁, X₂, X₃, and X₄, represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1, at least one of X₅, X₆, or X₇ representing a xylose or a fucose,
N represents an integer comprised between approximately 50 and approximately 300, and preferably comprised between approximately 50 and approximately 100,
or N represents an integer comprised between approximately 2 and approximately 50, and preferably comprised between approximately 2 and approximately 20, in particular between 5 and 12.

9. Use according to claim 1 or 2, of successive chains of at least two units represented by a compound of formula X₁-X₂-X₃-(X₄)ₙ in which n represents 0 or 1, X₁, X₂, X₃, and X₄ represent a glucose, optionally in reduced form, in α or β form, at least one of X₁, X₂, X₃, or X₄, being substituted by one or more sugars chosen from glucose, galactose, xylose, fucose, or arabinose, and/or by one or more osidic chains of formula X₅-X₆-(X₇)ₘ in which X₅, X₆, and X₇, independently from one another, represent a sugar chosen from glucose, galactose, xylose, fucose, or arabinose, and m represents 0 or 1, at least one of X₅, X₆, or X₇ representing a xylose or a fucose,
at least one of the units of said chains being such that at least one of the sugars or osidic chains bonded to X₁, X₂, X₃, or X₄, is respectively different from one of the sugars or osidic chains bonded to X₁, X₂, X₃, or X₄, of one or more of the other units of said chains.

10. Use according to claim 8 or 9, of polymers of formula [X₁-X₂-X₃-(X₄)ₙ]_{N} defined in claim 8, in which N represents an integer less than or equal to 12, and preferably less than or equal to 5, or of chains of units as defined in claim 9, in which the number of units is less than or equal to 12, preferably less than or equal to 5.

11. Use according to one of claims 8 to 10, of compounds of formula: 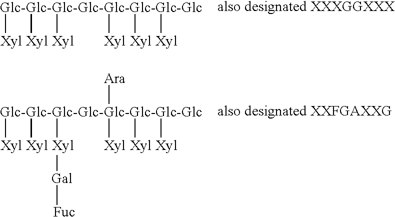
the glucose residue in the terminal position in the formulae of the compounds above, optionally being in reduced form, and in α or β form,
or also the compounds of formula XXFXXG, XLFGXXXG, XFFGXXXG, XXFGAXXG, GFGGFG.

12. Use according to one of claims 1 to 11, of xyloglucan polymers or oligomers, or of their derivatives, as obtained:
from plants, in particular by extraction from seeds, leaves, roots, fruits, in particular from apples, potato tubers, Echinacea, or seeds of Tropaeolum, or Hymenaea,
from plant cell suspensions of, in particular Acer, Rosa, Mentha, Nicotiana, Populus, Dioscorea deltoidea, Digitalis lanata, or Echinacea, in particular by extraction from cell walls, or by isolation from culture medium,
from fungi such as Lentinus edodes, Ganoderma lucidum, Schizophyllum commune, Trametes versicolor, Inonotus obliquus, and Flammulina velutipes, in particular by extraction from the mycelium, or by isolation from culture medium,
from seaweed, such as Ulva lactuca, or Ulva rigida.

13. Use according to one of the claims 1 to 11, of xyloglucan oligomers, or of derivatives, as obtained:
by chemical or chemoenzymatic synthesis, in particular by endotransglycosylation,
by fermentation of genetically modified bacterial strains,
by hydrolysis of polymers containing xyloglucan, or of glycans representing the glycan part of glycoproteins, using appropriate enzymes such as:
cellulases, and more particularly endo-β-D-1,4-glucanases of Trichoderma, such as that of Trichoderma viride, or of T reesei, or that of Aspergillus, such as that of A. niger, and of exo cellulases of Irpex lacteus, these enzymes being extraction or recombinant enzymes,
glycosidases such as β-D-glucosidase, α-L-fucosidase, α-L-xylosidase, these enzymes being extraction or recombinant enzymes,
said enzymatic treatment being followed by several stages of purification of the xyloglucan oligomers obtained, in particular by chromatography.

14. Process for the stimulation of glutathione reductase in plants, characterized in that it comprises a stage of plant treatment with at least one compound defined in one of claims 1 to 13, in particular by irrigation of the soil on which these plants are cultivated, with a composition comprising said compound, or by coating the seeds with such a composition, or by foliar spraying of such a composition in the field on the plants to be treated.

15. Use of the process according to claim 14, for the implementation of a process for the adaptation of the plants to an abiotic stress, such as adaptation to the cold, or to a hydric stress such as drought, humidity or salinity.

16. Process for the stimulation of phospholipase D production in plants, characterized in that it comprises a stage of plant treatment with at least one compound defined in one of claims 1 to 13, in particular by irrigation of the soil on which these plants are cultivated, with a composition comprising said compound, or by coating the seeds with such a composition, or by foliar spraying of such a composition in the field on the plants to be treated.

17. Use of the process according to claim 16, for implementation of a process for the control of flowering, and more particularly a process for the control of floral induction, of flowering duration, and of flower abscission, and/or for implementation of a process for the control of plant fructification, and more particularly of a process for the control of the triggering and duration of fruit maturation, of leaf and fruit abscission.

18. Process for the stimulation of the production of glycosyl hydrolases in plants, characterized in that it comprises a stage of plant treatment with at least one compound defined in one of claims 1 to 13, in particular by irrigation of the soil on which these plants are cultivated, with a composition comprising said compound, or by coating the seeds with such a composition, or by foliar spraying of such a composition in the field on the plants to be treated.

19. Use of the process according to claim 18, for implementation of a process for the induction of defence reactions against pathogens, such as bacteria, viruses, fungi.
